(19) United States
(12) Patent Application Publication
(10) Pub. No.: US 2010/0325048 A1
(43) Pub. Date: Dec. 23, 2010

(54) SYSTEM AND METHOD FOR PROVIDING CONSUMER TIP ASSISTANCE AS PART OF PAYMENT TRANSACTION

(76) Inventors: Mark Carlson, Half Moon Bay, CA (US); Shalini Mayor, Foster City, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/763,957

(22) Filed: Apr. 20, 2010

Related U.S. Application Data
(60) Provisional application No. 61/177,784, filed on May 13, 2009.
(60) Provisional application No. 61/173,371, filed on Apr. 28, 2009.

(51) Int. Cl. G06Q 40/00; G06Q 20/00

(52) U.S. Cl. 705/44

(57) ABSTRACT

Systems, apparatuses, and methods for conducting payment transactions are disclosed. In exemplary embodiments, a consumer may wish to add a tip or gratuity when paying for a good or service, such as a meal at a restaurant. Exemplary systems may generate an alert or other form of message based on the transaction, where the alert or message may include a suggested amount for a tip and/or provide the consumer with information that may be used to determine an amount for the tip. In some embodiments, the systems, apparatuses, and methods may automatically generate an estimated amount for the tip based on previously established user preferences, with the estimated amount being added to the underlying cost of the good or service when authorization is sought for the transaction.

### CROSS-REFERENCES TO RELATED APPLICATIONS

This application claims priority from U.S. Provisional Patent Application No. 61/173,371 (Attorney Docket 016222-048000US, filed Apr. 28, 2009) and 61/177,784 (Attorney Docket 016222-048300US, filed May 13, 2009), the contents of which are incorporated herein by reference in their entirety for all purposes.

### BACKGROUND

Embodiments of the present invention are directed to systems, apparatuses, and methods for providing a consumer with an alert regarding a payment transaction, and more specifically, to a system and method for providing a consumer with an alert or message that can be used to determine a suitable tip or gratuity for the transaction. The present invention is also directed to systems, apparatuses, and methods for enabling a consumer to conduct a payment transaction using a mobile device, and for providing the consumer with assistance in determining a gratuity for a transaction conducted using the mobile device.

Consumers use payment devices to conduct a variety of different types of transactions, such as for the purchase of goods or services from a merchant or service provider. The payment device may be a debit card, credit card, smart card, or a contactless payment device incorporated into a mobile phone or personal digital assistant (PDA). One type of transaction that a consumer may conduct is the purchase of a meal at a restaurant. As part of such a transaction, it is common to add a tip or gratuity to the cost of the meal. Similarly, there are other types of transactions for which it may be customary (or optional, but suggested) to leave a tip or gratuity. These types of transactions include the provision of certain types of personal services, etc.

In some situations a consumer may be unaware or uncertain of the appropriateness of a tip or gratuity, or of the amount of a tip or gratuity that would be considered customary as part of the transaction being conducted. In such a situation, the consumer may desire advice or a recommendation concerning the tipping custom in a certain country or for a certain type of purchase or service. Embodiments of the present invention address these and other problems, individually and collectively.

### SUMMARY

Embodiments of the present invention are directed to systems, apparatuses, and methods for providing a consumer with an alert regarding a payment transaction, and more specifically, to a system, apparatus, and method for providing a consumer with an alert or message that can be used to determine a suitable tip or gratuity for the transaction. The present invention is also directed to systems, apparatuses, and methods for enabling a consumer to conduct a payment transaction using a mobile device, and for providing the consumer with assistance in determining a gratuity for a transaction conducted using the mobile device.

Embodiments of the inventive system may include an alert or notification infrastructure that operates to generate an alert or message when a transaction satisfies certain conditions or consumer preferences. The consumer preferences may be set in advance of the transaction using a suitable interface, such as a web-based service interface that is accessible using a client device (such as a mobile phone, PDA, laptop computer or desktop computer). In response to the transaction satisfying the set of conditions or preferences, the system generates the alert or message and controls its delivery to the consumer. Similarly to the generation of the alert, the delivery mechanism may be determined by certain conditions or consumer preferences. The alert or message may contain transaction related data and may provide the consumer with a suggested gratuity based on characteristics of the transaction. The alert or message may also contain a link or other activate-able element to enable the consumer to request further assistance in determining the appropriate gratuity, or to request the suggestion of a gratuity amount if none has been provided. The suggested gratuity may be based on consumer preferences, be derived from a knowledge base containing information regarding tipping customs or protocols in different countries or locations, be based on previous consumer interactions with the same or a similar merchant, or be based on another suitable source of information or combination of sources of information.

In some embodiments, the inventive system may also operate to automatically generate a gratuity amount based on consumer preferences and to add that amount to the amount of the meal or service. The combined amount can then be included in an authorization request message for the transaction that is provided to an issuer. The combined amount can also be provided in a message to the consumer, who can then respond with an approval message. In some situations, the consumer may provide a gratuity amount in a message, with that amount being added to the meal or service. When the transaction is cleared, the amount of the gratuity actually submitted by the restaurant can be compared to the amount provided or authorized by the consumer. If the two amounts do not match, then the consumer can be alerted to the possibility of fraud in the transaction.

In one embodiment, the present invention is directed to an apparatus for processing a payment transaction, where the apparatus includes an electronic processor programmed to execute a set of instructions, a data storage device coupled to the processor, and the set of instructions contained in the data storage device, wherein when the set of instructions are executed by the processor, the apparatus processes the payment transaction by
receiving an authorization message for a payment transaction;
processing the authorization message to determine if data contained in the message satisfies a condition specified by a consumer participating in the payment transaction for generating a transaction alert message regarding a gratuity for the payment transaction;
accessing data regarding the consumer's desired content for the transaction alert message regarding the gratuity for the payment transaction if data contained in the authorization message satisfies the condition;
generating the transaction alert message containing information regarding the gratuity for the payment transaction based on the accessed data if data contained in the authorization message satisfies the condition; and
providing the transaction alert message to the consumer participating in the payment transaction.

In another embodiment, the present invention is directed to a method of processing a payment transaction, where the method includes receiving an authorization message for a payment transaction, processing the authorization message to determine if data contained in the message satisfies a condition specified by a consumer participating in the payment transaction for generating a transaction alert message regarding a gratuity for the payment transaction, accessing data regarding the consumer's desired content for the transaction alert message regarding the gratuity for the payment transaction if data contained in the authorization message satisfies the condition, generating the transaction alert message containing information regarding the gratuity for the payment transaction based on the accessed data if data contained in the authorization message satisfies the condition, and providing the transaction alert message to the consumer participating in the payment transaction.

In yet another embodiment, the present invention is directed to a system for processing payment transactions, where the system includes means for receiving a transaction authorization message from an acquirer, a processor programmed with a set of instructions, a data storage device coupled to the processor and containing the set of instructions, the set of instructions stored in the data storage device, means for enabling a consumer to provide preference data to the system, the preference data including data regarding when the consumer wants to be alerted regarding a payment transaction and a gratuity for the payment transaction, a database coupled to the processor containing the consumer provided preference data and data regarding gratuities for payment transactions, and means for delivering a message containing data regarding the gratuity for the payment transaction to the consumer to a device desired by the consumer, wherein when executed by the programmed processor, the set of instructions cause the system to process payment transactions by
receiving an authorization message for the payment transaction;
processing the authorization message to determine if data contained in the message satisfies a condition specified by the consumer for generating a transaction alert message regarding the gratuity for the payment transaction;
accessing the database to determine the consumer's desired content for the transaction alert message, the content including information regarding the gratuity for the payment transaction;
generating the transaction alert message containing information regarding the gratuity for the payment transaction; and
providing the transaction alert message to the consumer device desired by the consumer.

Other objects and advantages of embodiments of the present invention will be apparent to one of ordinary skill in the art upon review of the detailed description of the present invention and the included figures.

### BRIEF DESCRIPTION OF THE DRAWINGS

FIG. 1 is a block diagram illustrating the primary functional elements of a system for conducting a payment transaction and generating a form of tip or gratuity assistance for a consumer, in accordance with embodiments of the present invention;

FIG. 2 is a diagram illustrating the elements of a payment transaction system and the associated transaction flow, which may be used to enable a consumer to conduct a payment transaction and to generate and deliver an alert or tip related message to the consumer, in accordance with embodiments of the present invention;

FIG. 3 is a functional block diagram illustrating components of a payment processing system and elements that may interact with that system to enable a consumer to conduct a payment transaction and to deliver an alert or tip related message to the consumer, in accordance with embodiments of the present invention;

FIG. 4 is a functional block diagram illustrating components of an IP gateway that may be used as part of a system to enable a consumer to conduct a payment transaction and to deliver an alert or tip related message to the consumer, in accordance with embodiments of the present invention;

FIG. 5 is a flowchart illustrating the stages or operations of a process for enabling a consumer to register for a transaction alert, conduct a transaction, and receive an alert regarding a tip or gratuity for the transaction, in accordance with some embodiments of the present invention;

FIG. 6 illustrates an exemplary alert or message generated as the result of a transaction at a restaurant and provided to a consumer, in accordance with embodiments of the present invention;

FIG. 7 illustrates an exemplary alert or message that includes an element that may be selected by a consumer to obtain assistance in determining a tip or reporting a potentially fraudulent transaction, and which is generated as the result of a transaction at a restaurant, in accordance with embodiments of the present invention;

FIGS. 8(a) and 8(b) are block diagrams illustrating exemplary portable consumer devices or portable payment devices that may be used to conduct a transaction in which a consumer receives tip assistance, in accordance with embodiments of the present invention; and

FIG. 9 is a block diagram illustrating the primary functional components of a computer or computing system that may be used to implement an embodiment of the present invention.

### DETAILED DESCRIPTION

Embodiments of the present invention are directed to systems, apparatuses, and methods for conducting payment transactions. In exemplary embodiments, a consumer may wish to add a tip or gratuity when paying for a good or service, such as a meal at a restaurant. In these and other embodiments, exemplary systems may generate an alert or other form of message based on the transaction, where the alert or message may include a suggested amount for a tip and/or provide the consumer with information that may be used to determine an amount for the tip. In some embodiments, the inventive systems, apparatuses, and methods may automatically generate an estimated amount for the tip based on previously established user preferences, with the estimated amount being added to the underlying cost of the good or service when authorization is sought for the transaction. This enables a consumer to have a previously established amount (or percentage) automatically added to the cost of the good or service, and can act to reduce the possibility of a later dispute related to the amount of a tip or gratuity. Further, in some embodiments, a consumer may generate an approval message that indicates an authorized amount of a tip or gratuity that they have added to a bill and send that message to a payment processing system. The payment processing system may then use that information to confirm that the tip or gratuity amount submitted by a merchant is correct, and if not, to initiate an investigation into whether the transaction is fraudulent.

As noted, embodiments of the invention are directed to payment transaction systems, apparatuses, and methods. In a typical payment transaction, a consumer uses a portable consumer device (e.g., a credit card, debit card, a mobile phone containing a contactless payment device, etc.) to purchase goods or services from a merchant. Prior to describing embodiments of the present invention in greater detail, a brief description of the elements involved in a payment transaction, and their role in the processing of the payment transaction and in generating a transaction alert or message will be presented.

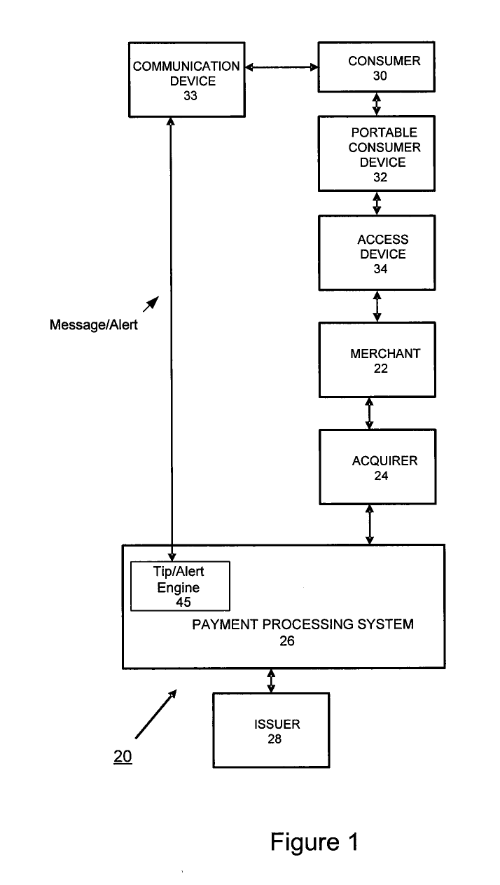

FIG. 1 is a block diagram illustrating the primary functional elements of a system 20 for conducting a payment transaction and generating a form of tip or gratuity assistance for a consumer, in accordance with embodiments of the present invention. System 20 includes a merchant 22 and an acquirer 24 associated with the merchant 22. In a typical payment transaction, a consumer 30 may purchase goods or services from the merchant 22 using a portable consumer device 32, which may function as a payment device. The acquirer 24 can communicate with an issuer 28 via a payment processing system or payment processing network 26. The consumer 30 may receive an alert or other message which relates to the transaction, via a communication device 33. The alert or other message may be presented to the consumer by display of data in graphic or textual form using an interface of communication device 33, or by presentation of another suitable form of data (such as an audio signal or message played through an earpiece). In some embodiments, portable consumer device 32 may be embedded in, or otherwise incorporated into, communication device 33, where communication device 33 may take the form of a mobile phone that includes a contactless chip which may be used to conduct a payment transaction. Consumer 30 may be an individual, or an organization such as a business that is capable of purchasing goods or services.

Portable consumer device 32 may be of any form suitable for use in implementing the present invention. For example, suitable portable consumer devices can be hand-held and compact so that they can fit into a consumer's wallet and/or pocket (e.g., pocket-sized). Such devices may include contact or contactless smart cards, ordinary credit or debit cards (with a magnetic strip and without an embedded microprocessor), keychain devices (such as the Speedpass™ commercially available from Exxon-Mobil Corp.), etc. Other examples of suitable portable consumer devices include cellular phones, personal digital assistants (PDAs), pagers, payment cards, security cards, access cards, smart media, transponders, and the like, where such devices may include an embedded or incorporated contactless chip or similar element. The portable consumer devices can function as debit devices (e.g., a debit card), credit devices (e.g., a credit card), or stored value devices (e.g., a stored value or prepaid card). Communication device 33 may also be in any form suitable for use in implementing the present invention. For example, a suitable communication device 33 can be a wireless phone, a form of Smartphone, a computer (such as a portable computer or other computing device), PDA, pager, or other device. As mentioned, in some embodiments, a single device may comprise both portable consumer device 32 and communication device 33, such as the example of a wireless phone configured to conduct payment transactions (e.g., by virtue of having a contactless chip incorporated into the phone).

Payment processing system 26 (sometimes referred to as a payment processing network) may include data processing subsystems and networks that implement operations used to support and deliver authorization services, exception file services, and clearing and settlement services. An exemplary payment processing system may include VisaNet. Payment processing systems such as VisaNet are able to process credit card transactions, debit card transactions, and other types of commercial transactions. VisaNet, in particular, includes a VIP system (Visa Integrated Payments system) which processes authorization requests for transactions and a Base II system which performs clearing and settlement services for the transactions.

In some embodiments, the payment processing system or network may include, or be communicatively coupled to, an IP Gateway that couples the payment processing system or network to a message delivery channel. The IP Gateway and delivery channel enable the delivery of messages among the parties to a transaction based on user preferences and if applicable, information regarding the transaction. Further, in some embodiments, the payment processing system or network may include, or be communicatively coupled to, a notification or alert generation engine that operates to determine whether to generate a notification or alert for a payment transaction. The notification or alert engine may also determine the contents of such a notification or alert. An example of an element that may perform some or all of the functions of a notification or alert engine is the tip engine to be described.

Payment processing system 26 may include a server computer. A server computer is typically a powerful computer or cluster of computers. For example, the server computer can be a large mainframe, a minicomputer cluster, or a group of servers functioning as a unit. In one example embodiment, the server computer may be a database server coupled to a Web server. Payment processing system 26 may use any suitable wired or wireless network, including the Internet, to facilitate communications and data transfer between the system elements depicted in the figure.

In some embodiments, payment processing system 26 may include, or be communicatively coupled to, a tip or gratuity engine 45. Tip or gratuity engine 45 may comprise a computing device, server computer, and/or a database and operates to provide consumer 30 with messages or other information that may be used by the consumer when conducting a payment transaction. In particular, tip or gratuity engine 45 may operate to provide a consumer with a suggested amount for a tip or with information that the consumer may use to determine an amount they wish to leave as a tip. The computing device, server computer or other data processing apparatus that operates as tip or gratuity engine 45 may comprise an electronic processor programmed with a set of instructions, where the set of instructions may be contained in a data storage device or memory that is communicatively coupled to the processor. When executed, the set of instructions may cause the programmed processor to implement some or all of the methods, processes, functions, or operations of the inventive transaction alert and tip assistance system.

The messages or information provided to the consumer may be part of a transaction alert process (such as one that notifies a consumer that their payment account has been used to conduct or to attempt to conduct a transaction) or may be part of a process for delivering specific types of information (such as suggested tip amounts) to a consumer. For example, tip or gratuity engine 45 may include or have access to data (typically contained in a searchable or indexed database) relating to, among other topics:
standard gratuity amounts (e.g., based on a percentage or percentages of the cost);
tipping customs based on geographical location;
suggested tip amounts based on characteristics of a location or merchant (e.g., based on merchant, type of service provided, or merchant category, where the category may be defined by a rating or average cost);
previously provided consumer preferences for tipping in certain situations;
suggested tip amounts based on previous consumer transactions with the same or a similar merchant or category of merchant;
suggested tip amounts based on the transactions of similar consumers with the same or a similar merchant or category of merchant, as determined by certain characteristics of the consumer (demographic data, spending habits, etc.); or
suggested tip amounts based on customers whom the consumer has indicated are representative of the consumer (such as friends, members of a common network, social network or group, etc.).

As will be discussed, the data contained in the database may be provided by any suitable source, including but not limited to, the consumer conducting the payment transaction, the results of processing or performing “data mining” on multiple payment transactions, consumers other than the consumer conducting the payment transaction, etc.

Tip engine 45 may be communicatively coupled to other elements of payment processing system 26, and as a result may receive or have access to information regarding or contained in an authorization request message, authorization response message, or other message relating to a transaction. Such information may enable tip engine 45 to determine data regarding a consumer or merchant involved in the transaction and based on that, to generate a suggested tip amount or provide other information of interest to the consumer. In some embodiments, tip engine 45 may determine whether the merchant or service provider involved in a transaction is one for which a tip or gratuity would normally be part of the transaction (e.g., a certain type or category of restaurant (dining as opposed to “fast food”) or provider of a personal service). This determination may be based on categories or conditions specified by a consumer, or categories or conditions specified by an entity involved in processing payment transactions. In some embodiments, a tip or gratuity alert may only be generated in situations where such a determination is made.

Note further that as a result of payment processing system 26 being involved in the processing of payment transaction data, including that provided by an acquirer or issuer, system 26 may collect and process transaction data for a multitude of consumers and merchants. Such transaction data may be processed or “data mined” to identify tipping or gratuity behaviors engaged in by consumers as a function of consumer demographics, transaction characteristics, merchant type, merchant location, etc. Such data mining may include the application of suitable heuristics, decision algorithms, neural network models, expert system rules, recommendation or collaborative filtering methods, etc. These tipping or gratuity behaviors may then be used as the basis for providing suggestions or recommendations to other consumers regarding the amount of a gratuity or the factors to consider when deciding on the amount of a gratuity.

In exemplary embodiments, tip engine 45 may perform one or more actions, processes, functions, or operations to provide the consumer with information regarding a tip or gratuity for a transaction. Such information may include, but is not limited to, one or more of:

(1) calculating a suggested tip for the transaction based on one or more characteristics of the consumer, merchant, or transaction;

(2) providing information or advice regarding a suggested tip or the customs for tipping in a specified location in response to a request from the consumer; or

(3) automatically adjusting a requested authorization amount for a transaction to include a previously selected tip amount or percentage based on consumer preferences for such types of transactions or other factors.

Further, tip engine 45 and/or other elements of payment processing system 26 may assist a consumer in detecting potential instances of fraudulent activity involving tipping procedures. This may be accomplished by the consumer sending a message to the payment processing system that informs the system of the amount of a tip that has been approved by the consumer. Later, when the payment processing system receives transaction data used in the clearance and settlement of the transaction, the amount of tip added to the transaction amount by the merchant can be compared to that approved by the consumer. If the two amounts do not match, then the consumer can be notified of the possibility of fraudulent activity and can take the appropriate actions.

Tip engine 45 or another suitable element may function as a notification engine which operates to generate or cause the generation of a message to be sent to consumer 30 (e.g., via communication device 33). The message may include relevant information regarding a transaction, such as a suggested tip amount, information regarding tipping customs, etc. The message may also (or instead) provide the consumer with an opportunity to request further information about the transaction, tipping customs, a suggested tip amount, etc. In some embodiments, tip engine 45 may include, be part of, or be in communication with an IP Gateway that is coupled to the payment processing system 26. The IP Gateway functions to couple the payment processing system to one or more communication channels to enable the delivery of a message or messages to the consumer. In some embodiments, tip engine 45 may be part of the infrastructure of issuer 28 or of another party to a transaction, such as a payment processor or other element of a payment processing system or network. As will be described, payment processing system 26, the IP Gateway, or an element of the issuer infrastructure may include an interface for use by the consumer to set preferences with regards to tipping or gratuity amounts, message delivery channels, triggers for the generation of an alert or message, etc. Such preferences may then be used by tip engine 45 and/or an IP Gateway to determine a suggested tip and to arrange for the delivery of a message containing that information to the consumer. Further, the consumer preferences may be used with a database populated with data concerning tip or gratuity amounts, tip customs, or tip practices as a function of location, merchant type, transaction type, etc. to generate a response to a consumer request for information or tip advice for a transaction.

Merchant 22 may receive communications or data from an access device 34 that can interact with portable consumer device 32. Examples of suitable access devices include point of sale (POS) devices or terminals, device readers for contact or contactless payment devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If access device 34 is a point of sale terminal, any suitable point of sale terminal may be used including card readers or other forms of payment device readers. Such card or payment device readers may include the capability to operate in any suitable contact or contactless mode of operation. For example, exemplary card readers or devices can include RF (radio frequency) antennas, NFC (near field communications) capable devices, magnetic stripe readers, etc. to enable interaction with portable consumer device 32.

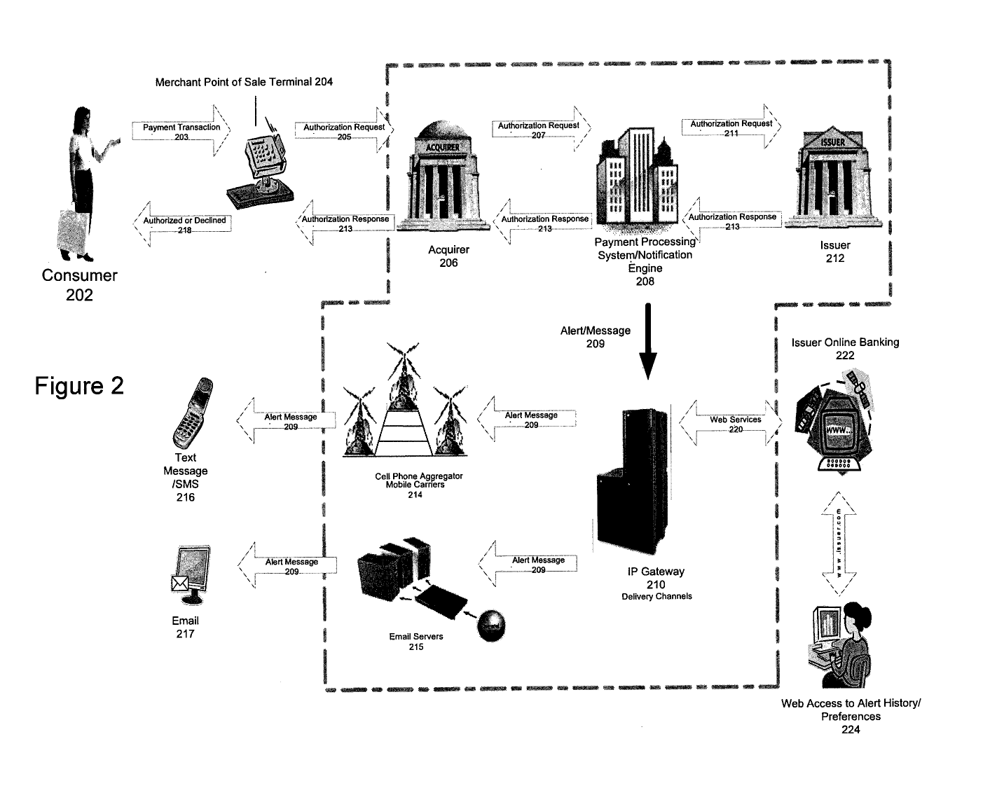

FIG. 2 is a diagram illustrating the elements of a payment transaction system and the associated transaction flow, which may be used to enable a consumer to conduct a payment transaction and to generate and deliver an alert or tip related message to the consumer, in accordance with embodiments of the present invention. As shown in the figure, in a typical purchase transaction, a consumer 202 purchases a good or service from a merchant by interacting with the merchant's point of sale terminal or device reader 204. The consumer may use a portable consumer device such as a credit card or debit card, or a payment device such as a contactless chip embedded in another device to conduct the transaction. For example, consumer 202 may take a credit card and may swipe it through an appropriate slot in the POS terminal. Alternatively, the POS terminal may be a contactless reader, and the portable consumer device may be a contactless device such as a contactless smart card or contactless chip embedded in another type of device.

In an exemplary transaction, consumer 202 initiates a payment transaction 203 using their payment device. The merchant's transaction processing system generates an authorization request message 205 that is forwarded to the acquirer 206. Acquirer 206 may process authorization request message 205 to obtain data for its records and/or to add relevant data to the message. Acquirer 206 forwards authorization request message 207 (which as described, may be the same as message 205 or may contain other data, including some or all of that contained in message 205) to payment processing system 208. In some embodiments, payment processing system 208 may include an alert or message 209 generating capability (such as the notification engine depicted in the figure), message routing system, and other elements responsible for payment transaction processing. Payment processing system 208 may also include, or be capable of communication and data exchange with an IP Gateway 210 which operates to control the delivery of alerts or messages to the consumer. As will be described in greater detail, the delivery of alerts or messages may be determined by one or more preferences established by the consumer, such as a preferred communications device based on location, time of day, type of transaction, etc. After receipt of authorization request message 207, payment processing system 208 may process the message to obtain data for its records and/or to add relevant data to the message. As will be described in greater detail, in some embodiments, payment processing system 208 may adjust an amount requested in transaction authorization request 207 to reflect a total of a transaction amount and a gratuity or tip amount, where the gratuity or tip amount is determined in accordance with previously provided preferences of the consumer. Payment processing system 208 then forwards authorization request message 211 to the issuer 212 of the consumer's payment device.

After issuer 212 receives authorization request message 211, issuer 212 processes the authorization request to determine whether to authorize the transaction, and sends an authorization response message 213 back to payment processing system 208 to indicate whether or not the current transaction is authorized. Issuer 212 may determine whether to authorize the transaction based on a transaction risk assessment or risk management process, consumer profile or transaction history data, merchant data, or other suitable information. Based on the contents of authorization response message 213 (and if relevant, other consumer or transaction related information), payment processing system 208 (or the notification engine component of the system) determines if an alert, message, or other form of communication 209 should be generated for the consumer with regards to the transaction. The determination of whether an alert, message, or other form of communication 209 should be generated may be based on characteristics of the transaction, consumer preferences with regards to the type of transactions for which they desire to be alerted (based on location, amount, merchant category, etc.), or other relevant data. As mentioned, such a determination may be made by a notification engine that is part of, or coupled to, payment processing system 208. The notification engine may access one or more databases to obtain data needed to determine if a communication 209 should be sent, and to determine the contents of such a communication. As will be described in further detail, the invention may process transaction authorization messages, where such messages include authorization request messages and authorization response messages, to provide a range of added value services to consumers with regards to gratuities and gratuity related information for a transaction.

Note that a consumer's preferences with regards to when they desire to be alerted about a transaction or about the status of a transaction may be provided as a result of a web services interface 220. Web services interface 220 may, in coordination with an issuer or provider of banking services 222, provide a consumer with access to a data input interface, form, etc. to enable the consumer to specify under what situations or conditions they wish to receive an alert. Data input interface 224 may be part of a web-site accessed by a consumer that enables the consumer to register for a transaction alert service, view their transactions, view alerts generated for the transactions, and to set their desired preferences for triggering the generation of an alert or other form of message. The situations or conditions that trigger the generation of an alert may include characteristics of the transaction (e.g., the amount, if the transaction exceeds a threshold, if the transaction is for a specific type of good or service, if the transaction is with a specific type of merchant), if the transaction occurs in a specified location or outside of a specified location, characteristics of the authorization response (e.g., if the transaction is declined or if approval is conditioned on some event or data), or another suitable characteristic. Data input interface 224 may enable a consumer to access a record of transactions for the previous month (or for any other suitable time period) for which a transaction alert or message has been generated in order to review their preferences and alter them if desired. In some embodiments, a consumer may be sent an email or other form of communication on a regular basis that contains a record of all transactions and transaction alerts that were generated for a certain time period. By accessing a suitable data input interface, the consumer may review and if desired, alter their preferences with regards to triggering alerts, alert content, and alert delivery mechanisms. This may enable a consumer to adjust the tip amount suggested for a merchant after multiple visits to the merchant, for example.

If it is determined that an alert, message, or other form of communication 209 should be generated and provided to the consumer, then payment processing system 208 may use IP Gateway 210 to control the delivery of the alert, etc., where IP Gateway 210 operates to route the alert to the appropriate communications channel and ultimately to a communications device of the consumer. Based on consumer preferences and/or other factors, IP Gateway 210 may control the delivery of an alert 209 to one of several communications channels and hence to one of several communications devices. For example, IP Gateway 210 may route an alert 209 to a mobile phone carrier 214 for delivery of alert 209 to a consumer's phone in the form of a text message (such as a SMS message) or interactive voice response (IVR) call 216. Similarly, IP Gateway 210 may route an alert 209 to an email server 215 for delivery of alert 209 to a consumer's computing device in the form of an email message 217.

Payment processing system 208 may forward authorization response message 213 to acquirer 206. Acquirer 206 sends response message 213 to the merchant to inform the merchant if the transaction has been approved or if it has been denied. After the merchant receives the authorization response message, the approval or denial of the transaction 218 may be displayed to the consumer using the merchant's point of sale terminal 204, or may be provided to the consumer in another format.

In certain use cases, the authorization request message can be a first authorization request message, and can comprise a preauthorization request message. The preauthorization request message may include an initial amount for a transaction, and can be approved or denied as described above. In some cases, the final transaction amount can differ from this initial transaction amount. For example, a restaurant bill can have an initial amount for food and taxes. Once this amount is approved, the consumer may add a tip to the initial amount, to create the final transaction amount. This final amount can be included in a second authorization request message, which can go through an approval/denial process as disclosed above. Other transactions that may have an initial and a final transaction amount can arise from activities that include hotel stays, gas purchases, use of rental cars, etc.

At the end of the day (or another relevant time period), a clearing and settlement process can be conducted by payment processing system 208. A clearing process is a process of exchanging financial details between and acquirer and an issuer to facilitate posting to a consumer's account and reconciliation of the consumer's settlement position. Clearing and settlement can occur simultaneously or as separate processes or operations.

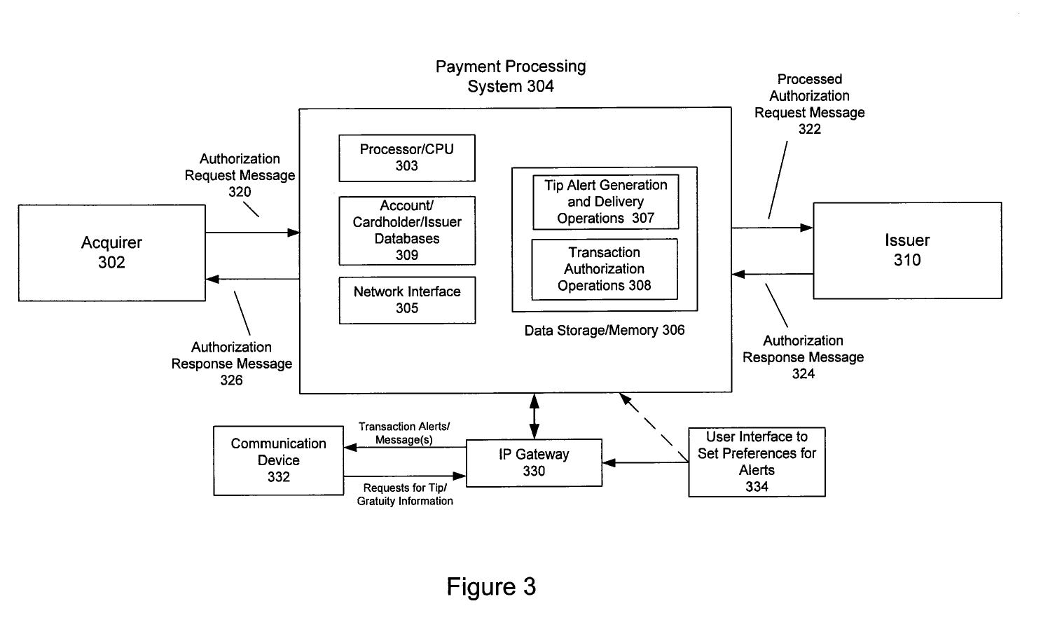

FIG. 3 is a functional block diagram illustrating components of a payment processing system (or payment processing network) 304 and elements that may interact with that system to enable a consumer to conduct a payment transaction and to deliver an alert or tip related message to the consumer, in accordance with embodiments of the present invention. As shown in the figure, elements that interact with system or network 304 include an acquirer 302 which provides an authorization request message 320 for a payment transaction to payment processing system or network 304. Payment processing system 304 may provide a processed authorization request message 322 to issuer 310 to assist issuer 310 in deciding whether to authorize or deny a transaction. Issuer 310 provides payment processing system 304 with an authorization response message 324 containing an indication of whether the transaction has been approved or denied. Authorization response message 326 (which may be the same as message 324, or may contain other information) is provided to acquirer 302 to inform acquirer 302 (and ultimately the merchant and consumer) if the transaction has been approved or denied.

In processing one or more of the transaction authorization messages, where such messages include transaction authorization request messages 320 and transaction authorization response messages 324, payment processing system or network 304 may utilize one or more of the components or elements depicted in FIG. 3. Such components or elements include a processor or central processing unit 303 that is programmed to execute a set of instructions, where some or all of those instructions may be stored in data storage device or memory 306. The instructions may include instructions which when executed, cause payment processing system or network 304 to perform one or more transaction authorization processing functions or operations (as suggested by instructions or instruction set 308) and/or tip alert or message generation and delivery operations (as suggested by instructions or instruction set 307). In performing these operations, processor or central processing unit 303 may access one or more databases 309 containing payment account, cardholder, and/or issuer data (such as the previously described consumer preferences for the generation, contents, and delivery of an alert or message regarding a transaction). Payment processing network 304 may utilize network interface 305 to enable communication with other elements depicted in FIG. 3. Such elements may include IP Gateway 330 which operates to enable the delivery of a transaction alert or message to a communication device 332 belonging to a consumer. IP Gateway 330 also enables the delivery of a request for tip or gratuity information from the consumer to payment processing system 304 in order to permit system 304 to generate a response to the consumer's request for information. As has been described, a consumer may access a user interface 334 to indicate their preferences for when an alert or message should be generated, the preferred contents of such an alert or message, and the preferred delivery channel for such an alert or message. User interface 334 may provide information regarding a consumer's preferences to payment processing system 304 in addition to, or instead of to, IP Gateway 330 (as suggested by the dashed line between interface 334 and payment processing system 304).

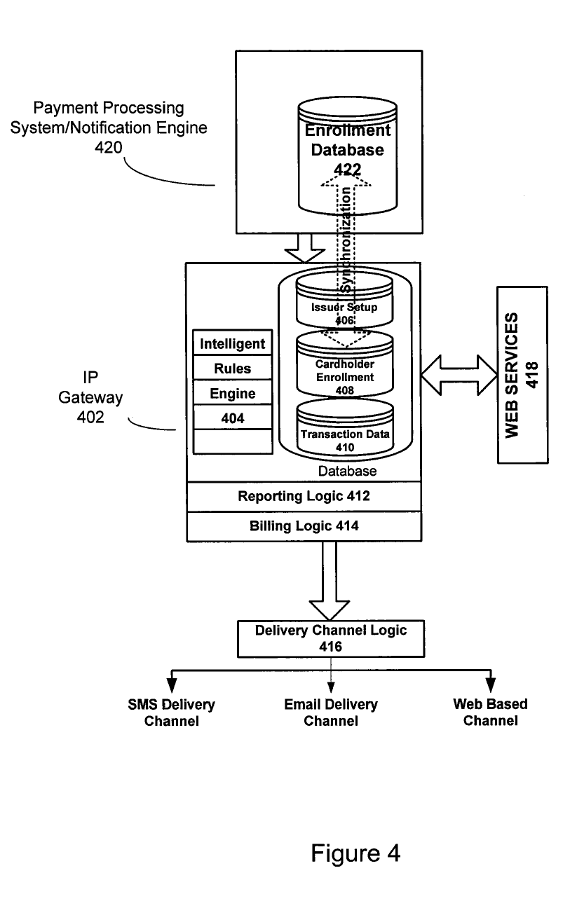

FIG. 4 is a functional block diagram illustrating components of an IP Gateway 402 that may be used as part of a system to enable a consumer to conduct a payment transaction and to deliver an alert or tip related message to the consumer, in accordance with embodiments of the present invention. The figure also depicts how IP Gateway 402 may interface with other elements of the transaction alert architecture described with reference to FIGS. 2 and 3. In some embodiments, IP Gateway 402 can include programmed processors and/or server computers that include an intelligence/rules engine 404 (for determining how to handle alerts and transactions, based on specific transaction parameters and/or consumer preferences), and one or more databases for storing issuer information 406, cardholder enrollment data 408, and transaction data 410 (e.g., records of transactions and alerts). IP Gateway 402 can also include computer readable media and programmed processors for executing reporting and billing logic (shown as elements 412 and 414) and used for tasks such as reporting on billings, status, fraud, consumer data, etc. IP Gateway 402 may also include a messaging interface for implementing delivery channel logic 416. The messaging interface allows IP Gateway 402 to send and receive messages using any suitable communication channel, such as Text (SMS) messages, email, web based delivery, etc. IP Gateway 402 may further be capable of providing web services 418, for enabling access by a consumer using one or more web enabled browsers. For example, web services 418 can allow for the enrollment of consumers in the tip alert and other services, and the setting of consumer preferences for the generation, content, and delivery of alerts. Enrollment may be performed by filling in fields on a website (one or more consumers at a time), or may be done in batch, by file delivery from an issuer or other party. The web services can further provide customer service functions for the consumer and the issuer. As described with reference to FIG. 2 and FIG. 3, IP Gateway 402 is coupled to and capable of communication and data transfer with payment processing system 420 which may include or be coupled to a notification engine (depicted as element 208 of FIG. 2 or element 304 of FIG. 3) and which is involved in the processing of transaction data and authorization messages (where such messages may include transaction authorization request messages and transaction authorization response messages). As shown in FIG. 4, payment processing system/notification engine 420 may include an enrollment database 422 that contains data concerning those consumers enrolled in an alert service, with enrollment database 422 being synchronized with cardholder enrollment database 408 as needed to ensure that alerts are generated for the proper consumers in accordance with consumers' preferences.

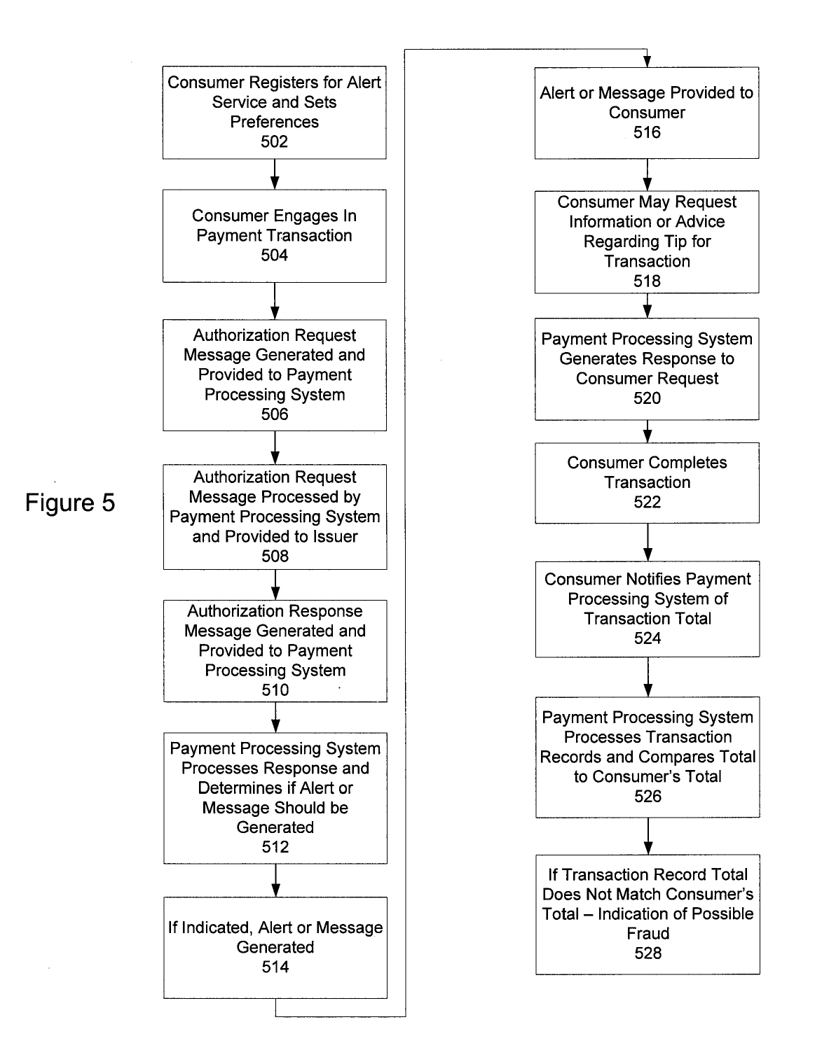

FIG. 5 is a flowchart illustrating the stages or operations of a process for enabling a consumer to register for a transaction alert, conduct a transaction, and receive an alert regarding a tip or gratuity for the transaction, in accordance with some embodiments of the present invention. As shown in the figure, a consumer registers for a transaction alert service in order to be provided with an alert or message when a transaction that satisfies the specified preferences or conditions is conducted by the consumer (stage 502). As part of the registration process, the consumer may specify the conditions under which they wish to be “alerted” to a transaction or to a characteristic of a transaction. These conditions may be provided using a web-site and suitable user interface that is configured to provide data to an IP Gateway or payment processing system or network. The conditions or triggers for the generation and sending of an alert may include characteristics of the transaction (e.g., the type or amount), characteristics of the merchant (e.g., the nature of the good or service provided, the merchant category or type), the location of the transaction, consumer specified indicia of fraud that the consumer wishes to be made aware of, etc. In addition to specifying their preferences with regards to the generation of an alert, a consumer may also specify their preferences with regards to how an alert is to be delivered to them (e.g., the alert or message format, the delivery channel, the consumer device to which the alert or message is to be delivered, times at which an alert or message should or should not be delivered, etc.). Further, the consumer may also specify what information they want to be contained in a transaction alert or message (e.g., an estimated or suggested tip, several possible tips based on the level of service received by the consumer, a user interface element that may be activated to enable the consumer to obtain information about a suggested tip or merchant, information regarding whether there is a specific tipping protocol for the type of merchant, type of service, location, etc.). The consumer preferences may be provided by entering data, selecting from a list of possible factors or conditions, checking a box to indicate the selection of a factor or condition, etc.

At some time after the consumer has set their preferences for the generation, delivery and content of an alert or message concerning a transaction, the consumer engages in a payment transaction using a payment device (stage 504). As described with reference to FIG. 2 and FIG. 3, this typically causes an authorization request message to be generated by a merchant and provided to the merchant's acquirer and then to a payment processing system (stage 506). The authorization request message may contain information regarding the merchant, such as a merchant type code (e.g., for a department store, restaurant, hotel, etc.), a merchant location code (which may correspond to a region or country), the amount of the transaction, etc. The authorization request message may be subjected to further processing by the payment processing system before being provided to the issuer (stage 508).

For example, in some embodiments, the data contained in the authorization request message may be recognized as indicating that the transaction is one for which a consumer wishes to automatically adjust the amount of the transaction to reflect the addition of a tip or gratuity. In such an embodiment, data contained in the authorization request message may be recognized by the payment processing system or network as indicating that the transaction is one for which the consumer has requested that the transaction amount be adjusted by a previously specified amount or percentage. For example, the data contained in the authorization request message may indicate that the transaction is for one or more of a restaurant, a specific type or category of restaurant, a restaurant located in a specific location, country, or type of establishment, etc. Based on the data contained in the authorization request message and the consumer's preferences, the inventive system may recognize that the consumer wishes to adjust the amount being requested for authorization for the transaction and be able to determine the amount of a tip or gratuity that the consumer wishes to add to the amount of the underlying meal, service, or product.

For example, the consumer's preferences may specify one or more of the types of services or products for which a tip or gratuity should be added, provide a list of specific merchants for which a tip or gratuity should be added, provide a tip or gratuity amount (typically specified as a percentage of the underlying cost for the service, either as a function of the total of cost plus tax or the cost alone) to be added to the bill to obtain a total amount to be included in the authorization request, etc. In response to recognizing that the consumer desires to adjust the amount for the transaction contained in the authorization request message and determining the amount to be added as the adjustment, the payment processing system or network may modify the data contained in the authorization request message and forward the message to the issuer. Note that in some embodiments, the consumer preferences may indicate that the tip or gratuity to be added to the amount for the transaction contained in the authorization request message should be determined by other rules or heuristics, such as by the percentage amount previously left by the consumer at the same or similar restaurants, the percentage amount that is typically left by patrons of that restaurant, the percentage amount generally recognized as customary, etc.

The issuer receives the authorization request message and processes the data contained in the message to determine if it will authorize the transaction. The issuer then generates an authorization response message and provides the message to the payment processing system or network (stage 510). The payment processing system or network processes the authorization response message and, based on the data contained in the message and the consumer's preferences, determines if an alert or message should be generated (stage 512) for the transaction. As discussed, the consumer's preferences may indicate that an alert or message should be generated based on one or more characteristics of the transaction that are specified by the consumer. Such characteristics may include, but are not limited to, the type of transaction, the amount of the transaction, the location of the transaction, whether there are specific features of the transaction that might suggest fraud, etc.

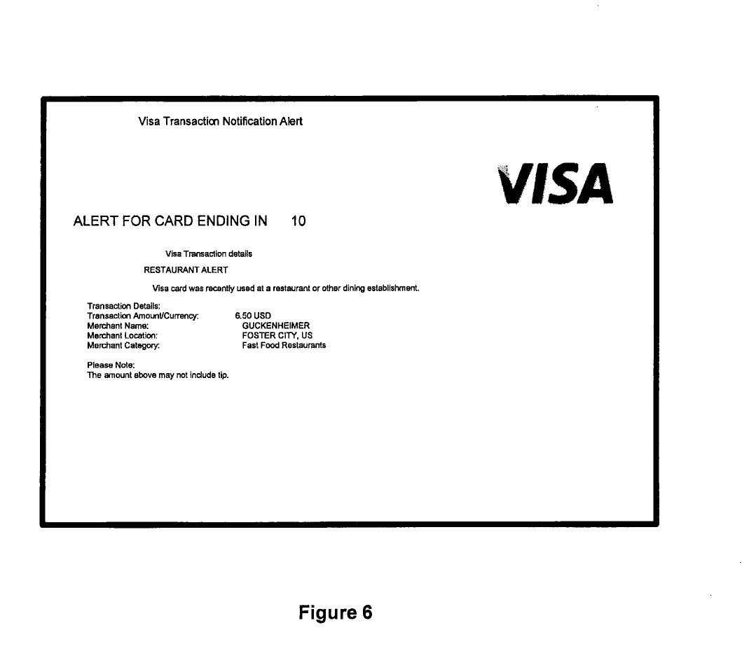

If the transaction data and the consumer's preferences indicate that an alert or message should be generated, then the payment processing system or network (which, as described may include or be coupled to a notification engine) generates the alert or message (stage 514). The alert or message may contain information concerning the transaction: for example, an identification of the payment account used for the transaction, an identification of the type of transaction (such as whether the transaction was conducted using a phone, online interface, etc.), the amount of the transaction, the merchant for the transaction, the location of the merchant, etc. An exemplary alert or message generated as the result of a transaction at a restaurant is shown in FIG. 6. Note that the contents of the alert or message may also be determined in whole or in part by the consumer's preferences, such as if the consumer desires that a transaction alert contain information about a suggested tip or the tip amounts previously left by the consumer for the same or similar merchants or services. The alert or message is delivered in accordance with the consumer's preferences, for example, as a SMS message, email, web-page, phone call, or other form of communication. As shown in FIG. 6, an alert may provide a consumer with transaction and merchant information that may be relevant to a consumer determining if the transaction is fraudulent and if not fraudulent, to determining the amount of a tip or gratuity that the consumer desires to add to the underlying cost of the service.

In addition to the transaction related information, the alert or message may also contain (depending on the consumer's preferences) information regarding actions that the consumer has requested be taken in response to specific transaction characteristics (such as a suggestion of a tip or gratuity amount, or notification that a tip or gratuity has been included in the transaction total in accordance with the consumer's wishes), or an offer to provide the consumer with additional advice regarding tipping or tipping customs for the transaction. For example, if the consumer has set their preferences to indicate that they want advice on a tip or gratuity to be provided as part of the alert or message, such information may be generated and provided based on information provided by the consumer (such as a percentage for any “suggested tip”) and/or data contained in a database that stores transaction and tip related data. Such a database may contain data regarding tipping and tipping protocols based on the type of restaurant, the location of the restaurant, price category of the restaurant, prior transactions engaged in by the consumer or a suitable group of consumers, etc. The data in such a database may be processed or “data mined” to determine tipping behaviors of multiple consumers and as a result to provide recommendations or information to a consumer engaged in a transaction.

The alert or message is then provided to the consumer, with the delivery method or channel determined in whole or in part by the consumer's previously set preferences (stage 516). Typically, an IP Gateway is used to route the alert or message to the desired communication network for delivery to the consumer on the consumer's communication device or devices. Note that a suggested tip amount or other information that the consumer has requested by virtue of their preferences may also be provided in a message separate from the transaction alert.

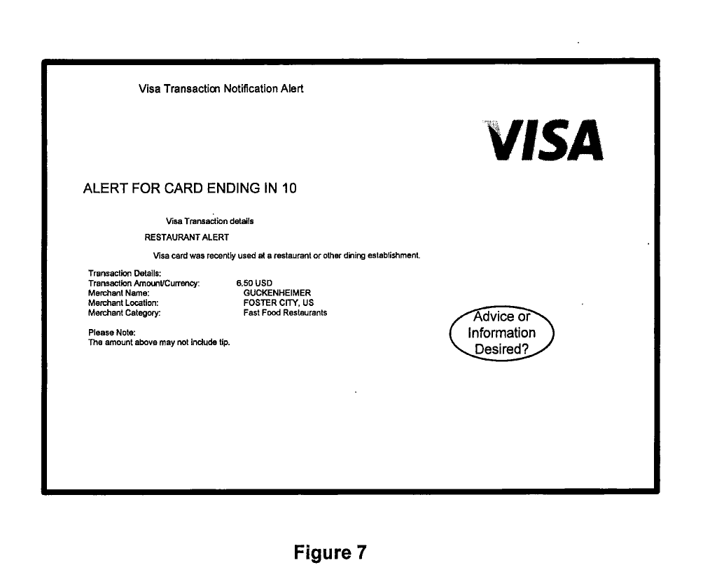

If the alert or message does not contain a suggested tip amount or if a suggested amount is provided but the consumer desires further information, then the consumer may activate a “help”, “advice”, “more information” or similar element in the alert or message in order to request assistance (stage 518). FIG. 7 illustrates an exemplary alert or message that includes an element that may be selected by a consumer to obtain assistance in determining a tip or reporting a potentially fraudulent transaction, and which is generated as the result of a transaction at a restaurant, in accordance with embodiments of the present invention. As shown in the figure, the alert or message includes a “button” or other form of element that may be selected or activated by the consumer to indicate that they desire assistance in determining the appropriate amount for a tip or gratuity for the transaction.

Further, in some embodiments, the alert or message may include a “button” or other form of element that may be selected or activated by the consumer to report the transaction described in the alert as fraudulent or potentially fraudulent (where in response, the payment processing system or network may initiate an investigation, contact the consumer, contact the issuer for the payment device, or take any other appropriate action). In some embodiments, the request is provided to the IP gateway (as a result of the IP gateway being capable of communication and data transfer with a communications network that is used by the consumer's communication device) and then to the payment processing system or network for processing and the generation of a response (stage 520). In response to the request for assistance (or to reporting the transaction as potentially fraudulent), the payment processing system or network may provide the consumer with a menu, list, or other set of selectable elements that represent the types or categories of information or actions that are available to the consumer. Instead of using a selectable element and a menu, in some embodiments, the consumer may send a message (such as a SMS message) that contains keywords recognized by the payment processing system or network and that correspond to a request for information (e.g., “tip advice”, or “tip advice based on location”). In either case, upon receipt of the request the payment processing system or network may provide the consumer with specific information or with a menu or list from which the consumer can generate a further request for the information or action they desire.

If applicable, the payment processing system or network generates a response to the consumer's request that includes the information that the consumer has indicated that they want with regards to the transaction, a suggested tip amount, tipping customs, etc. Typically, the response will be constructed based on information contained in the consumer's preferences and/or data contained in a database that stores transaction and tip related data. The payment processing system or network generates the response and it is provided to the consumer. The consumer then completes the transaction (stage 522). This may involve approving a bill to which the consumer has added a tip amount (either manually at their table, or via a message provided to the merchant by the acquirer as a result of a communication by the consumer with the payment processing system, for example). The bill may also include a tip that has been added to the underlying cost of the transaction as a result of the consumer having set a preference that causes a tip amount to be added to the amount of the transaction specified in the authorization request message (as at stage 508). Note that if the tip amount has already been added to the authorization request message, then the consumer may, in some cases, leave the merchant location without having to perform any other actions with regards to approving the bill. After the consumer has completed the transaction, the restaurant or other merchant sends the transaction data to its acquirer, who then provides the transaction data (which includes the tip amount) to the payment processing system or network.

In some embodiments, after completion of the transaction, the consumer may generate a message on their communications device and provide that message to the payment processing system or network (via the IP Gateway for example). The message may include a total for the transaction that represents the price for the underlying service, taxes, and a tip or gratuity that the consumer has approved for payment (stage 524). The total transaction amount message may be provided via any suitable communications method or channel, including, but not limited to, an SMS message, an email message, or a phone call. As will be described, the consumer's message containing the total transaction amount may be used by the payment processing system or network to identify possible instances of fraud, such as where a restaurant employee makes an adjustment to the amount of the tip approved by the consumer.

The payment processing system or network processes the completed transaction and generates a record of the transaction. The record contains a total amount that was “cleared” for the transaction. The payment processing system or network may then compare the total amount for the transaction submitted by the merchant to the total amount contained in the consumer's message (stage 526). If the two amounts do not match, then this may be an indication of fraud or that the consumer was incorrect in the total provided in their message (stage 528). In either case, the payment processing system or network may generate an alert or message informing the consumer of a possible discrepancy and requesting that the consumer contact the appropriate party to discuss the situation.

Note that although generation of an alert or message has been described with reference to the processing of an authorization response message (as at stage 512), in some embodiments, an alert or message may instead (or also) be generated at another stage of the process, such as after the processing of an authorization request message (as at stage 508). An example of an alert or message generated in response to processing of an authorization request message might be one that notifies a consumer that an amount for a tip or gratuity has automatically been added to the amount requested for approval for a transaction.

As described, embodiments of the inventive system, apparatuses, and methods can provide a consumer with added-value services and benefits with regards to tips and gratuities, including, but not limited to:
(1) providing a suggested tip or gratuity amount as part of an alert or message sent to the consumer in response to a transaction authorization response message for a payment transaction from an issuer;
(2) providing a mechanism in the alert or message for the consumer to request information about the suggested tip or about tipping practices or customs, or to request a suggested tip amount, and in response to the consumer request, provide the consumer with the requested information;
(3) automatically adjusting a transaction amount contained in a transaction authorization request message from an acquirer to include a tip amount or percentage previously approved by the consumer (i.e., a process that may be termed “tip augmentation”);
(4) receiving a message from the consumer containing the total amount for a transaction that was approved by the consumer (i.e., for the underlying service, taxes, and a tip amount approved by the consumer) and comparing that amount to the total transaction amount submitted by the merchant to identify potential instances of fraud or consumer error (i.e., as a means of detecting possible instances of “tip fraud” or consumer error);
(5) if a potential instance of tip fraud or consumer error is identified, then generating an alert or message to the consumer concerning that situation, and enabling the consumer to obtain assistance to resolve the issue; and
(6) providing the consumer with a web interface and/or other mechanism to enable the consumer to register for a tip or gratuity assistance service and to set the consumer's preferences for when they wish to be notified about a transaction, how they wish to be notified about the transaction, and the desired contents of the notification alert or message.

As described, in exemplary embodiments, an alert or message can be generated for a transaction based on preferences set by a consumer. The alert or message can include relevant information for the transaction. As used herein, “relevant information” can comprise information relating to an additional amount for the transaction, such as a tip or local tipping customs or protocols. The relevant information, such as a suggested tip protocol, other transaction related assistance, or tip amounts, can be sent to consumers that have registered for an alerts program, such as a tip alerts service. The relevant information can be sent as part of a transaction alert or in a stand alone message. In exemplary embodiments, the tip alert can be a text message sent to a wireless phone associated with the consumer (e.g. using SMS). In some embodiments the tip alert may comprise an email, instant message, voice message, or use any other suitable communications channel.

The inventive tip alert or tip assistance service can provide a consumer with assistance in determining a suitable amount of a tip or gratuity. The service can help calculate a tip amount and can provide guidance on tips and tipping protocols in different situations. In some embodiments, when a card is swiped at a restaurant (or other situation in which a tip or gratuity might be appropriate), an alert can be generated and provided to the consumer to assist them in calculating a tip. Thus, a tip alert message can be generated (i.e., the relevant information can be determined and provided, etc.) upon the generation of a first authorization message (e.g., a preauthorization request message). In some embodiments, the tip alert can be sent to the consumer prior to a second authorization message being sent. The relevant information contained in the tip alert can then be used by the consumer to adjust the transaction amount to reflect the tip or gratuity they desire.

For example, the tip engine or other element of the payment processing system may receive a first authorization request message, a first authorization response message, or other suitable message that includes the initial amount of a transaction associated with a portable consumer payment device (such as after the portable consumer payment device is used at a restaurant). The tip engine can then determine relevant information for the transaction. The tip engine can calculate suggested tip amounts (i.e., additional amounts for the transaction) based upon the initial transaction amount. In exemplary embodiments, the initial transaction amount can be inclusive of tax. In certain embodiments, the initial transaction amount can be exclusive of tax. In certain embodiments, the tip engine can calculate additional amounts for both tax inclusive and tax exclusive initial transaction amounts. The tip engine can then generate and transmit an alert or message to the consumer that includes the relevant information, such as by sending a text message to a wireless phone associated with the consumer. This may be accomplished in conjunction with the operation of an IP Gateway, or another apparatus that functions to couple a first network such as the Internet to a second network such as a wireless communications network. This relevant information can include the calculated suggested tip amounts (e.g., 10%, 15%, and 20% of the initial transaction amount), and any other suitable information. The consumer can choose one of the suggestions, and indicate to the merchant that this additional amount should be included in the final transaction amount.

Exemplary embodiments of the present invention can include alerts that advise a consumer if a tip is customary in the situation or not. The relevant information can include advice on tip protocol for the merchant, taking into account location (e.g. country of the merchant or other relevant party), local culture, merchant type or category, etc. For example, in certain countries, a tip is not a certain percentage of a bill, but may comprise a rounding of the initial amount to the next higher whole number. In another example, the relevant information can advise the consumer if a tip or an added charge are normally included by the merchant in the bill (so that no tip, or less tip, is required). In some embodiments, the relevant information can calculate a tip for selectable percentages, and can include what the total (final transaction amount) would be for each selectable percentage. For example, the selectable tip percentages can be any or all of 10%, 15%, 18%, 20%, 22%, etc. The tip percentages may be selected by any of the consumer, the issuer, the merchant, the payment processing system, etc. In certain embodiments, the relevant information can advise the consumer on the average or most common tip for the merchant, or class or type of transaction. For example, the tip alert may state that “Most patrons tip 17.5% at Joe's Diner.” In certain embodiments, the relevant information can include a tip calculation based upon a consumer's selected settings or preferences. For example, a consumer may, prior to or during the transaction, request alerts containing a calculation for a tip amount of 20% pre-tax, and a calculated total. In certain embodiments, the tip alert can follow the initiation of a transaction (such as after the preauthorization process), or can be requested by the consumer interactively during the transaction.

In exemplary embodiments, the tip engine or another element of the payment processing system or network can maintain a merchant database along with a record of consumer preferences. For example, if a first consumer prefers to tip at 20% post-tax, the database can record this information. The database can also contain other relevant information, such as merchant tipping policy and location or culture based tipping protocols. Following a purchase, such as after the transaction has been preauthorized (and prior to a second authorization that may include the added tip or gratuity), the relevant information can be accessed, processed, and provided to the consumer. Each time a consumer registered in the alerts program or service conducts a transaction, such as by swiping their card at a merchant terminal or communicating with a merchant terminal using a contactless payment device, a transaction alert notification can be sent (using an IP Gateway or other suitable system). The relevant information can be sent in or appended to the transaction alert notification. The relevant information can include the initial transaction amount plus tip amount suggestions (e.g., 10%, 15%, or 20%). The relevant information can also include an average tip amount by merchant, merchant type or category, or suggestion for tip protocol by country (if the transaction occurs outside of the consumer's home country).

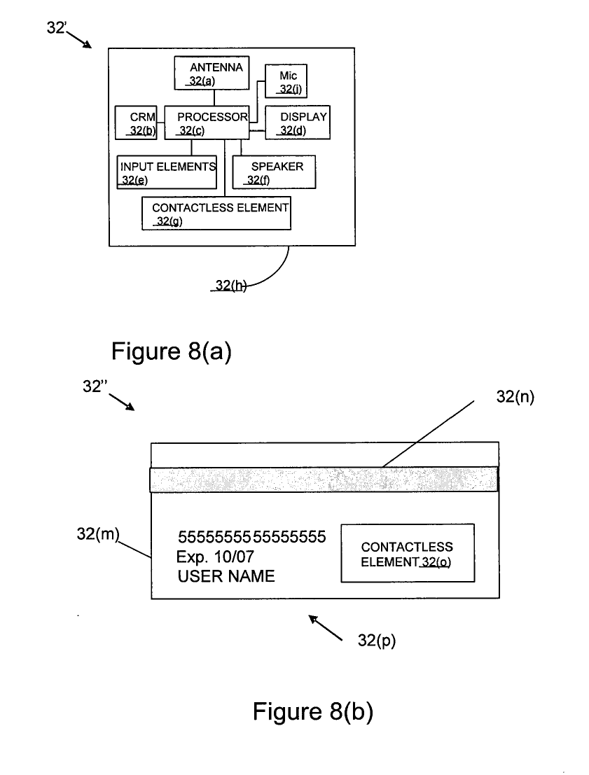

The inventive processes, functions, operations, and methods for providing tip or gratuity assistance or advice to a consumer may be utilized in situations where the consumer uses one of a variety of portable consumer devices or portable payment devices to conduct a transaction. FIGS. 8(a) and 8(b) are block diagrams illustrating exemplary portable consumer devices or portable payment devices that may be used to conduct a transaction in which a consumer receives tip assistance, in accordance with embodiments of the present invention.

As noted, the portable consumer device 32 shown in FIG. 1 may be in any suitable form. As discussed, suitable portable consumer devices can be hand-held and compact so that they can fit into a consumer's wallet and/or pocket (e.g., pocket-sized). They may include smart cards (with or without an embedded contactless element), credit or debit cards (with a magnetic strip and without a microprocessor), keychain devices (such as the Speedpass™ commercially available from Exxon-Mobil Corp.), etc. Other examples of portable consumer devices include those containing a contactless element such as a cellular phone (e.g., the wireless phone 32′ described below), a personal digital assistant (PDA), or a pager. Suitable portable consumer devices also include payment cards, security cards, access cards, smart media, transponders, and the like. The portable consumer devices may function as a debit device (e.g., a debit card), a credit device (e.g., a credit card), or a stored value device (e.g., a prepaid or stored value card).

An exemplary portable consumer device 32′ in the form of a phone may comprise a computer readable medium and a body as shown in FIG. 8(a). Note that communication device 33 of FIG. 1 may comprise the portable consumer device 32′, such as the situation in which the communication device is a mobile phone that incorporates a contactless element. Note further that FIG. 8(a) shows a number of components, and that the portable consumer devices used in implementing embodiments of the present invention may comprise any suitable combination or subset of such components. The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, uniquely derived keys, encryption algorithms, etc. The memory may also store information such as financial information, transit information (e.g., a subway or train pass), access information (e.g., as in access badges), etc. Financial information may include information such as bank account information, bank identification number (BIN), credit or debit card number information (e.g., the primary account number or PAN), account balance information, expiration date, consumer information such as name, date of birth, etc. Any of this information may be transmitted or otherwise provided by the portable consumer device 32′ as part of conducting a transaction.

Information in the memory of the device may also be in the form of data tracks, such as those traditionally associated with credit cards. Such tracks may include Track 1 and Track 2. Track 1 (which may be referred to as the “International Air Transport Association” track) stores more information than Track 2, and contains the cardholder's name as well as account number and other discretionary data. This track is sometimes used by the airlines when securing reservations with a credit card. Track 2 (which may be referred to as the “American Banking Association” track) is currently the most commonly used data track. This is the track that is read by ATMs and credit card checkers. The ABA (American Banking Association) designed the specifications of this track and all world banks are expected to abide by it. It contains the cardholder's account, encrypted PIN, plus other discretionary data.

The portable consumer device 32′ may further include a contactless element 32(g), which is typically implemented in the form of a semiconductor chip (or other data storage element) with an associated wireless transfer (e.g., data transmission) element, such as an antenna or transducer. Contactless element 32(g) is associated with (e.g., embedded within) portable consumer device 32′ and in some embodiments, data or control instructions transmitted via a cellular network may be applied to contactless element 32(g) by means of a contactless element interface (not shown). If present, the contactless element interface functions to permit the exchange of data and/or control instructions between the portable consumer device circuitry (and hence the cellular network) and an optional contactless element 32(g).

Contactless element 32(g) may be capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32′ and a device reader or point of sale terminal. Thus, in some embodiments, portable consumer device 32′ may be capable of communicating and transferring data and/or control instructions via both a cellular network and a near field or short range communications capability.

Portable consumer device 32′ may also include a processor 32(c) (e.g., a microprocessor or central processing unit) for processing instructions that cause the execution of the functions and operations of the portable consumer device 32, and a display 32(d) to allow a consumer to see phone numbers and other information and messages (such as tip alerts or related messages). Portable consumer device 32′ may further include input elements 32(e) to allow a consumer to input information into the device, a speaker 32(f) to allow the consumer to hear voice communications, music, etc., and a microphone 32(i) to allow the consumer to transmit voice inputs through the portable consumer device 32. Portable consumer device 32′ may also include an antenna 32(a) for wireless data transfer (e.g., data transmission using a wireless communications or cellular network).

If the portable consumer device is in the form of a debit, credit, or smartcard, then the portable consumer device may optionally have features such as a magnetic strip. As a result, such devices may be capable of operating in either a contact or contactless mode.

An example of a portable consumer device 32″ in the form of a card is shown in FIG. 8(b). FIG. 8(b) shows a portable device that includes a substrate 32(m). A contactless element 32(o) for interfacing with an access device 34 may be present on or embedded within substrate 32(m). Consumer information 32(p) such as an account number, expiration date, and consumer name may be printed or embossed on the card. A magnetic stripe 32(n) may also be on the substrate 32(m). The magnetic strip may contain one or more of the data tracks previously described as Track 1 format or Track 2 format.

As shown in FIG. 8(b), portable consumer device 32″ may include both a magnetic stripe 32(n) and a contactless element 32(o). In other embodiments, either the magnetic stripe 32(n) or the contactless element 32(o) may be present as part of portable consumer device 32″.

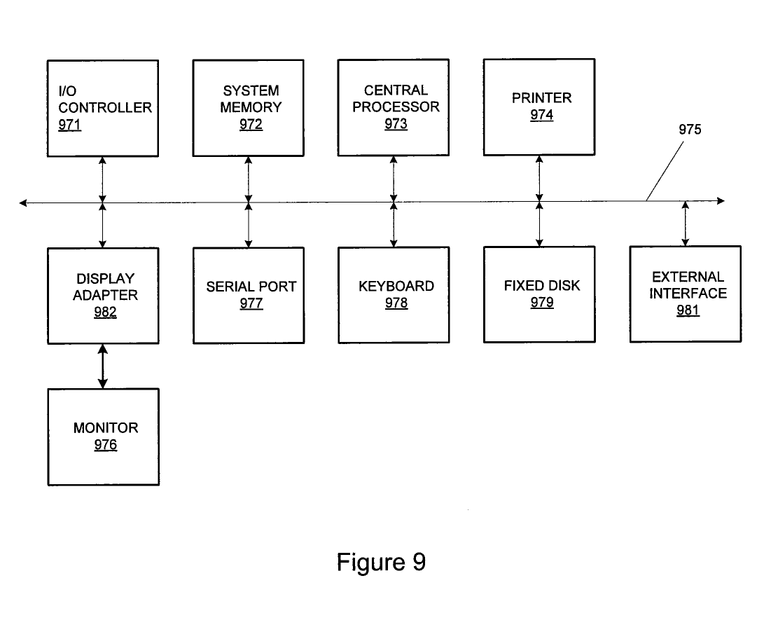

The various components, entities, and elements depicted in FIGS. 1-4 may operate one or more computers or computing apparatuses to facilitate the functions and operations described herein as part of the inventive system. Some or all of the components of the computing apparatus to be described with reference to FIG. 9 may be part of a server, group of servers, data processor, computer, or computing device that is part of a payment processing system or network, notification engine, IP Gateway, tip alert engine, etc. which implement one or more of the functions, processes, methods, or operations of the tip alert service of the present invention. The elements depicted in FIGS. 1-4, including any servers or databases, may use any suitable number of subsystems to facilitate the functions described herein. Examples of such subsystems or components are shown in FIG. 9, which is a block diagram illustrating the primary functional components of a computer or computing system that may be used to implement an embodiment of the present invention. The subsystems shown in FIG. 9 are interconnected via a system bus 975. Additional subsystems such as a printer 974, keyboard 978, fixed disk 979 (or other memory comprising computer readable media), monitor 976, which is coupled to display adapter 982, and others are shown. Peripherals and input/output (I/O) devices, which couple to I/O controller 971 (which can be a processor or other suitable controller), can be connected to the computer system by any number of means known in the art, such as serial port 977. For example, serial port 977 or external interface 981 can be used to connect the computer apparatus to a wide area network such as the Internet, a mouse input device, or a scanner. The interconnection via system bus allows the central processor (which take the form of a central processing unit or microprocessor) 973 to communicate with each subsystem and to control the execution of instructions from system memory 972 or the fixed disk 979, as well as the exchange of information between subsystems. The system memory 972 and/or the fixed disk 979 may embody a computer readable medium.

Embodiments of the invention are not limited to the above-described embodiments. For example, although separate functional blocks are shown for an issuer, payment processing system, IP Gateway, and acquirer, some entities perform multiple of these functions and may be included in embodiments of the invention. Further, as has been described, in a typical embodiment of the present invention, an apparatus such as an electronic processor is communicatively coupled to a data storage device which contains a set of instructions that may be executed by the processor when it is programmed. When executed, the instructions cause the programmed processor to implement the methods, processes, functions and operations described herein.

Embodiments of the present invention provide a consumer with advice or information related to a gratuity that may be applicable to a payment transaction, such as the purchase of a meal at a restaurant. The invention can assist the consumer to determine the proper amount for a gratuity and/or provide information to the consumer regarding tipping customs or protocols that enable the consumer to determine the amount they desire to add to a transaction as a gratuity. The invention can also generate a suggested amount for a gratuity based on the characteristics of the transaction (such as the amount of the transaction, the merchant, the location, the type of restaurant, etc.), the consumer's previous behavior with regards to gratuities, the behavior of other, similar consumers with regards to gratuities, or other relevant factors. In some embodiments, the invention can function to expedite a payment transaction by automatically adding a previously specified amount or percentage for a gratuity to a transaction amount contained in a transaction authorization request message. In other embodiments, the invention can assist in detecting potential fraudulent behavior by providing a notification to the consumer if the total amount for a transaction submitted by a merchant (including the gratuity) exceeds that authorized by the consumer.

Specific details regarding some of the above-described aspects are provided above. The specific details of the aspects may be combined in any suitable manner without departing from the spirit and scope of embodiments of the invention. For example, portable consumer device authentication, consumer authentication, back end processing, and consumer transaction notification may be combined or partially combined in some embodiments of the invention. However, other embodiments of the invention may be directed to specific embodiments relating to each individual aspect, or specific combinations of these individual aspects.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. An apparatus for processing a payment transaction, comprising:
an electronic processor programmed to execute a set of instructions;
a data storage device coupled to the processor; and
the set of instructions contained in the data storage device, wherein when the set of instructions are executed by the processor, the apparatus processes the payment transaction by
receiving an authorization message for a payment transaction;
processing the authorization message to determine if data contained in the message satisfies a condition specified by a consumer participating in the payment transaction for generating a transaction alert message regarding a gratuity for the payment transaction;
accessing data regarding the consumer's desired content for the transaction alert message regarding the gratuity for the payment transaction if data contained in the authorization message satisfies the condition;
generating the transaction alert message containing information regarding the gratuity for the payment transaction based on the accessed data if data contained in the authorization message satisfies the condition; and
providing the transaction alert message to the consumer participating in the payment transaction.

2. The apparatus of claim 1, wherein the information regarding the gratuity for the payment transaction includes a suggested gratuity amount for the payment transaction.

3. The apparatus of claim 1, wherein the information regarding the gratuity for the payment transaction includes information on how the consumer can obtain additional information regarding the gratuity for the payment transaction.

4. The apparatus of claim 1, wherein the authorization message is an authorization request message and the apparatus processes the payment transaction by automatically adding a gratuity amount to the transaction amount contained in the authorization request message prior to providing the authorization request message to an issuer.

5. The apparatus of claim 1, wherein after providing the transaction alert message to the consumer participating in the payment transaction, the apparatus processes the payment transaction by
receiving a message from the consumer containing a total amount for the payment transaction that is approved by the consumer, the total amount including a gratuity approved by the consumer;
comparing the total amount for the payment transaction approved by the consumer to a total amount for the payment transaction provided by a merchant for the payment transaction; and
generating a message for the consumer indicating the possibility of fraud in the payment transaction if the total amount for the payment transaction approved by the consumer is not substantially the same as the total amount for the payment transaction provided by a merchant for the payment transaction.

6. The apparatus of claim 1, wherein after providing the transaction alert message to the consumer participating in the payment transaction, the apparatus processes the payment transaction by
receiving a request from the consumer for additional information regarding the gratuity for the payment transaction;
accessing a database containing data regarding gratuities for payment transactions in response to receiving the request from the consumer;
generating a message containing a response to the request from the consumer, the response including data obtained from the database; and
providing the message containing the response to the request to the consumer.

7. The apparatus of claim 6, wherein the database contains data regarding one or more of
gratuity amounts based on a percentage of the cost of the transaction;
tipping customs based on a location of the merchant for the transaction;
the consumer's preferences for tipping in certain situations;
suggested tip amounts based on previous consumer transactions with the same or a similar merchant or category of merchant;
suggested tip amounts based on the transactions of similar consumers with the same or a similar merchant or category of merchant; or
suggested tip amounts based on customers whom the consumer has indicated are representative of the consumer.

8. The apparatus of claim 6, wherein providing the transaction alert message to the consumer participating in the payment transaction further comprises providing the message to the consumer on the consumer's mobile communications device.

9. The apparatus of claim 8, wherein the mobile communications device is a mobile phone or personal digital assistant.

10. The apparatus of claim 1, wherein processing the authorization message further comprises processing the authorization message to determine if a merchant or service provider involved in the payment transaction is one for which a gratuity would normally be provided.

11. A method of processing a payment transaction, comprising:
receiving an authorization message for a payment transaction;
processing the authorization message to determine if data contained in the message satisfies a condition specified by a consumer participating in the payment transaction for generating a transaction alert message regarding a gratuity for the payment transaction;
accessing data regarding the consumer's desired content for the transaction alert message regarding the gratuity for the payment transaction if data contained in the authorization message satisfies the condition;
generating the transaction alert message containing information regarding the gratuity for the payment transaction based on the accessed data if data contained in the authorization message satisfies the condition; and
providing the transaction alert message to the consumer participating in the payment transaction.

12. The method of claim 11, wherein the information regarding the gratuity for the payment transaction includes a suggested gratuity amount for the payment transaction.

13. The method of claim 11, wherein the information regarding the gratuity for the payment transaction includes information on how the consumer can obtain additional information regarding the gratuity for the payment transaction.

14. The method of claim 11, wherein the authorization message is an authorization request message and the method further comprises automatically adding a gratuity amount to the transaction amount contained in the authorization request message prior to providing the authorization request message to an issuer.

15. The method of claim 11, further comprising:
receiving a message from the consumer containing a total amount for the payment transaction that is approved by the consumer, the total amount including a gratuity approved by the consumer;
comparing the total amount for the payment transaction approved by the consumer to a total amount for the payment transaction provided by a merchant for the payment transaction; and
generating a message for the consumer indicating the possibility of fraud in the payment transaction if the total amount for the payment transaction approved by the consumer is not substantially the same as the total amount for the payment transaction provided by a merchant for the payment transaction.

16. The method of claim 11, further comprising:
receiving a request from the consumer for additional information regarding the gratuity for the payment transaction;
accessing a database containing data regarding gratuities for payment transactions in response to receiving the request from the consumer;
generating a message containing a response to the request from the consumer, the response including data obtained from the database; and
providing the message containing the response to the request to the consumer.

17. The method of claim 11, wherein providing the transaction alert message to the consumer participating in the payment transaction further comprises providing the message to the consumer on the consumer's mobile communications device.

18. The method of claim 11, further comprising processing the authorization message to determine if a merchant or service provider involved in the payment transaction is one for which a gratuity would normally be provided.

19. A system for processing payment transactions, comprising:
means for receiving a transaction authorization message from an acquirer;
a processor programmed with a set of instructions;
a data storage device coupled to the processor and containing the set of instructions;
the set of instructions stored in the data storage device;
means for enabling a consumer to provide preference data to the system, the preference data including data regarding when the consumer wants to be alerted regarding a payment transaction and a gratuity for the payment transaction;
a database coupled to the processor containing the consumer provided preference data and data regarding gratuities for payment transactions; and
means for delivering a message containing data regarding the gratuity for the payment transaction to the consumer to a device desired by the consumer;
wherein when executed by the programmed processor, the set of instructions cause the system to process payment transactions by
receiving an authorization message for the payment transaction;
processing the authorization message to determine if data contained in the message satisfies a condition specified by the consumer for generating a transaction alert message regarding the gratuity for the payment transaction;
accessing the database to determine the consumer's desired content for the transaction alert message, the content including information regarding the gratuity for the payment transaction;
generating the transaction alert message containing information regarding the gratuity for the payment transaction; and
providing the transaction alert message to the consumer device desired by the consumer.

20. The system of claim 19, wherein the transaction authorization message is an authorization request message and the system processes payment transactions by automatically adding a gratuity amount to the transaction amount contained in the authorization request message prior to providing the authorization request message to an issuer.

21. The system of claim 19, wherein after providing the transaction alert message to the consumer device desired by the consumer, the system processes payment transactions by
receiving a message from the consumer containing a total amount for the payment transaction that is approved by the consumer, the total amount including a gratuity approved by the consumer;
comparing the total amount for the payment transaction approved by the consumer to a total amount for the payment transaction provided by a merchant for the payment transaction; and
generating a message for the consumer indicating the possibility of fraud in the payment transaction if the total amount for the payment transaction approved by the consumer is not substantially the same as the total amount for the payment transaction provided by a merchant for the payment transaction.

22. The system of claim 19, wherein after providing the transaction alert message to the consumer device desired by the consumer, the system processes payment transactions by
receiving a request from the consumer for additional information regarding the gratuity for the payment transaction;
accessing the database containing data regarding gratuities for payment transactions in response to receiving the request from the consumer;
generating a message containing a response to the request from the consumer, the response including data obtained from the database; and
providing the message containing the response to the request to the consumer.
